(19) United States
(12) Patent Application Publication
(10) Pub. No.: US 2025/0243886 A1
(43) Pub. Date: Jul. 31, 2025

(54) TOLERANCE COMPENSATION DEVICE

(71) Applicant: Ford Global Technologies, LLC, Dearborn, MI (US)

(72) Inventors: Michael Robertson, West Bloomfield, MI (US); Venkatesh Krishnan, Canton, MI (US); Segundo Baldovino, Novi, MI (US)

(21) Appl. No.: 18/426,828

(22) Filed: Jan. 30, 2024

(51) Int. Cl. F16B 5/02; F16B 37/00

(52) U.S. Cl. CPC F16B 5/025; F16B 37/002

(57) ABSTRACT

An assembly includes a housing having an internal bore defined by a bore surface and a fastener that is insertable within the internal bore. A receiving portion is located within a vehicle body structure and has an opening that is aligned with the internal bore. The fastener includes threads that cut into the bore surface as the fastener is rotated relative to the housing to secure the housing to the vehicle body structure via the receiving portion, or the fastener cooperates with an insert positioned within the internal bore to secure the housing to the vehicle body structure via the receiving portion.

### TECHNICAL FIELD

This disclosure relates generally to a tolerance compensation device and, more particularly, to a tolerance compensation device that is used to attach various components to a vehicle body structure.

### BACKGROUND

A tolerance compensation device may be used to mount a component, such as a headlamp for example, to a vehicle body structure. The tolerance compensation device adjusts tolerance stack ups on the body and ensures a good fit between parts.

### SUMMARY

An assembly according to an exemplary aspect of the present disclosure includes, among other things: a housing having an internal bore defined by a bore surface; a fastener insertable within the internal bore; a receiving portion within a vehicle body structure that has an opening that is aligned with the internal bore; and wherein the fastener includes threads that cut into the bore surface as the fastener is rotated relative to the housing to secure the housing to the vehicle body structure via the receiving portion, or wherein the fastener cooperates with an insert positioned within the internal bore to secure the housing to the vehicle body structure via the receiving portion.

In a further non-limiting embodiment of the foregoing assembly, the internal bore comprises a threaded bore and wherein the insert comprises a threaded outer surface that threadably engages the threaded bore via a threaded interface such that rotation of the fastener causes the insert to rotate until a head of the insert abuts against the vehicle body structure.

In a further non-limiting embodiment of any of the foregoing assemblies, the insert comprises an inner surface that defines an insert bore that extends from the head to a distal end of the insert, and wherein the insert includes a plurality of thread grabbers that extend radially inward from the inner surface to engage outer threads on the fastener.

In a further non-limiting embodiment of any of the foregoing assemblies, the head of the insert is in an initial position that is spaced from the vehicle body structure by a gap, and wherein the fastener engages the plurality of thread grabbers causing the insert to rotate via the threaded interface between the insert and the housing to move the insert to a final position where the gap is eliminated and the head of the insert abuts against the vehicle body structure.

In a further non-limiting embodiment of any of the foregoing assemblies, the receiving portion comprises a receiving fastener, and wherein when the insert is in the final position, the fastener is rotated through the insert such that a distal end of the fastener is received within the opening of the receiving fastener to secure the housing to the vehicle body structure.

In a further non-limiting embodiment of any of the foregoing assemblies, the insert comprises an inner surface that defines an insert bore that extends from the head to a distal end of the insert, and wherein the fastener comprises a self-threading fastener that cuts into the inner surface to rotate the insert relative to the housing.

In a further non-limiting embodiment of any of the foregoing assemblies, the receiving portion comprises a receiving fastener, and wherein the head of the insert is in an initial position that is spaced from the vehicle body structure by a gap, and wherein the self-threading fastener rotates the insert to a final position where the gap is eliminated and the head of the insert abuts against the vehicle body structure, and wherein the fastener rotates through the insert such that a distal end of the fastener extends outwardly of the insert.

In a further non-limiting embodiment of any of the foregoing assemblies, the insert includes a first anti-rotation feature that cooperates with a second anti-rotation feature on the housing to prevent rotation of the insert out of the housing in a first condition, and wherein, in a second condition, a rotational force of the fastener within the insert overrides the first and second anti-rotation features to attach the housing to the vehicle body structure.

In a further non-limiting embodiment of any of the foregoing assemblies, the fastener is selectable between at least a first fastener having a first size and a second fastener having a second size different than the first size, and wherein the insert comprises an inner surface that defines an insert bore that extends from the head to a distal end of the insert, and wherein the insert bore includes a first internal feature to accommodate the first fastener and a second internal feature to accommodate the second fastener.

In a further non-limiting embodiment of any of the foregoing assemblies, the fastener includes threads that cut into the bore surface.

In a further non-limiting embodiment of any of the foregoing assemblies, the fastener extends from a head to a distal end, and wherein the fastener comprises a first body portion extending from the head and a second body portion extending from the first body portion to the distal end, wherein the first body portion is defined by a first diameter and the second body portion is defined by a second diameter that is less than the first diameter, and wherein the threads comprise a first set of threads formed on the first body portion and a second set of threads formed on the second body portion.

In a further non-limiting embodiment of any of the foregoing assemblies, the receiving portion comprises a receiving fastener, and wherein the first set of threads cut into the bore surface and the second set of threads threadably engage the opening in the receiving fastener as the fastener is rotated within the internal bore.

In a further non-limiting embodiment of any of the foregoing assemblies, the fastener includes a shoulder between the first body portion and the second body portion, and wherein the fastener is rotated from an initial position where the shoulder is spaced from the vehicle body structure by a gap to a final position where the shoulder abuts against the vehicle body structure to eliminate the gap.

In a further non-limiting embodiment of any of the foregoing assemblies, the fastener comprises a first fastener and the threads comprise external threads, and wherein the first fastener includes a bore that extends from a head of the first fastener to a distal end of the first fastener, and wherein the bore includes internal threads that cooperate with a second fastener.

In a further non-limiting embodiment of any of the foregoing assemblies, the second fastener extends from a head to a distal end, and wherein the second fastener is threaded into the bore of the first fastener until the head of the second fastener abuts against the head of the first fastener, and wherein the first fastener and the second fastener are subsequently rotated together such that the external threads cut into the bore surface of the housing.

In a further non-limiting embodiment of any of the foregoing assemblies, the receiving portion comprises a receiving fastener, and wherein the first fastener and the second fastener are rotated together until the distal end of the second fastener is received within the opening of the receiving fastener and the distal end of the first fastener engages with vehicle body structure.

A method according to another exemplary aspect of the present disclosure includes, among other things: inserting a fastener into an internal bore in a housing, wherein the internal bore is defined by a bore surface; providing a receiving portion with a vehicle body structure such that an opening in the receiving portion is aligned with the internal bore; and cutting into the bore surface with external threads on the fastener as the fastener is rotated relative to the housing to secure the housing to the vehicle body structure via the receiving portion, or positioning an insert with in the internal bore to cooperate with the fastener to secure the housing to the vehicle body structure via the receiving portion.

In a further non-limiting embodiment of the foregoing method, the method includes positioning the insert with in the internal bore, and wherein the internal bore comprises a threaded bore and wherein the insert comprises a threaded outer surface that threadably engages the threaded bore via a threaded interface, and including rotating the fastener to cause the insert to rotate until a head of the insert abuts against the vehicle body structure.

In a further non-limiting embodiment of any of the foregoing methods, the insert comprises an inner surface that defines an insert bore that extends from the head to a distal end of the insert, and the insert includes a plurality of thread grabbers that extend radially inward from the inner surface to engage outer threads on the fastener, or the fastener comprises a self-threading fastener.

In a further non-limiting embodiment of any of the foregoing methods, the receiving portion comprises a receiving fastener, and the method includes cutting into the bore surface with external threads on the fastener as the fastener is rotated relative to the housing to secure the housing to the vehicle body structure via the receiving fastener.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a perspective view of a vehicle body portion with a housing used to mount a component to a vehicle body structure.

FIG. 2 is an exploded view of one example of a tolerance compensation device.

FIG. 3A is a perspective view of an insert of the tolerance compensation device of FIG. 2.

FIG. 3B is an end view of the tolerance compensation device of FIG. 3A.

FIG. 4 is a perspective view of a housing bore that receives the tolerance compensation device of FIG. 3A.

FIG. 5 is a perspective view of the insert as installed in the housing of FIG. 4.

FIG. 6A is a first installation position for the tolerance compensation device of FIG. 2.

FIG. 6B is a subsequent installation position for the tolerance compensation device of FIG. 2.

FIG. 6C is a final installation position for the tolerance compensation device of FIG. 2.

FIG. 7A is a first installation position for another example of a tolerance compensation device.

FIG. 7B is a subsequent installation position for the tolerance compensation device of FIG. 7A.

FIG. 7C is a subsequent installation position for the tolerance compensation device of FIG. 7B.

FIG. 7D is a final installation position for the tolerance compensation device of FIG. 7C.

FIG. 7 E is a section view of the final installation position of FIG. 7D.

FIG. 8A is a section view of another example of an insert for a tolerance compensation device.

FIG. 8B shows a first type of fastener as installed in the insert of FIG. 8A.

FIG. 8C shows a second type of fastener as installed in the insert of FIG. 8A.

FIG. 9 is an exploded view of another example of a tolerance compensation device.

FIG. 10 is a end view of a fastener from the tolerance compensation device of FIG. 9 as installed within the housing.

FIG. 11A is a first installation position for another example of the tolerance compensation device of FIG. 9.

FIG. 11B is a subsequent installation position for the tolerance compensation device of FIG. 11A.

FIG. 11C is a subsequent installation position for the tolerance compensation device of FIG. 11B.

FIG. 11D is a final installation position for the tolerance compensation device of FIG. 11C.

FIG. 12 is an exploded view of another example of a tolerance compensation device.

FIG. 13A is a first installation position for the tolerance compensation device of FIG. 12.

FIG. 13B is a subsequent installation position for the tolerance compensation device of FIG. 12.

FIG. 13C is a final installation position for the tolerance compensation device of FIG. 12.

FIG. 14A is a section view of break-away tabs in a first condition.

FIG. 14B is a section view of break-away tabs in a second condition.

### DETAILED DESCRIPTION

This disclosure details a tolerance compensation device that is used to attach various components to a vehicle body structure. For example, a tolerance compensation device can be used to attach headlamps, sensor brackets, fenders, trim, etc. to the vehicle body structure. The tolerance compensation device adjusts tolerance stack-ups on the body and ensures a good fit and alignment between parts.

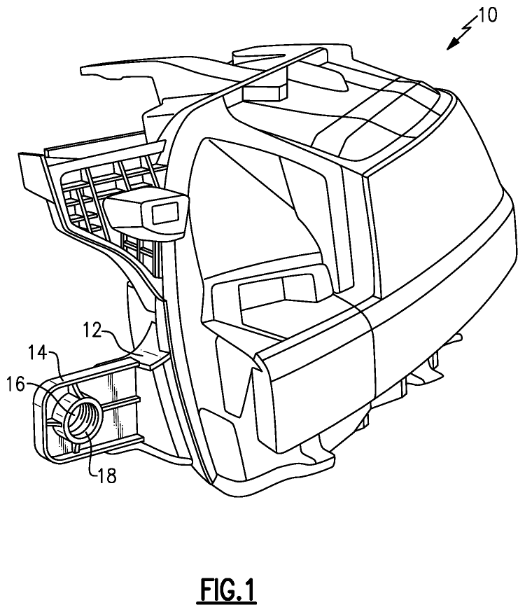

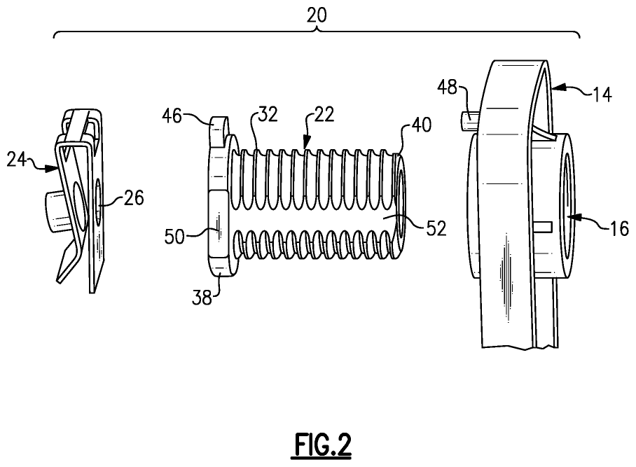

With reference to FIG. 1, a vehicle body 10 includes a vehicle body structure 12 that is used to mount various components to the vehicle body 10. In one example, a component housing 14 is mounted to the vehicle body structure 12. In the example shown in FIG. 1, the housing 14 comprises a headlamp housing; however, the housing 14 could comprise a housing for another type of vehicle component or could comprise a bracket, for example.

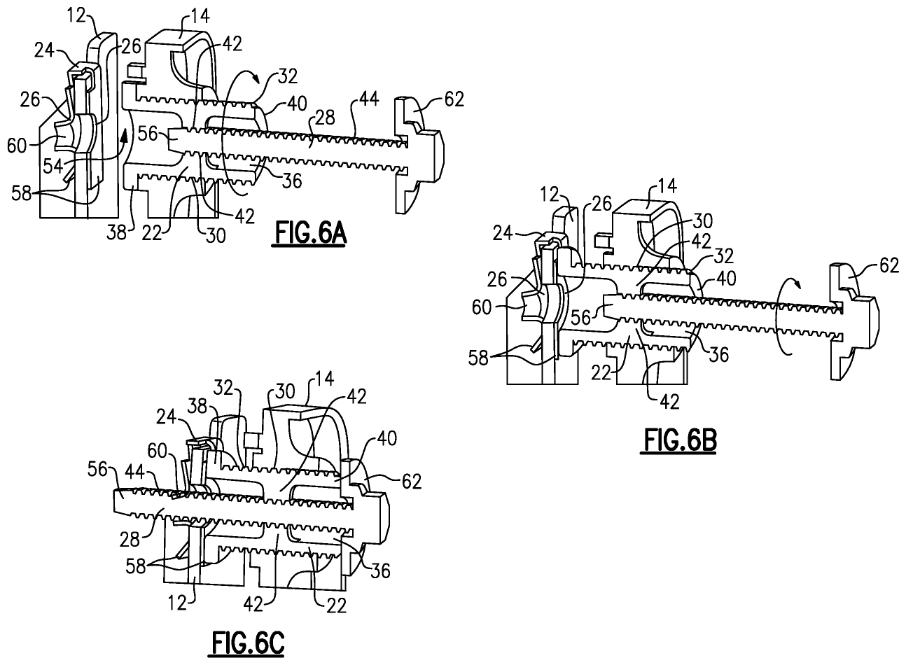

The component housing 14 has an internal bore 16 that is defined by a bore surface 18. The component housing 14 is attached to the vehicle body structure 12 using any of various known attachment interfaces. In one example shown in FIG. 1, a tolerance compensation device 20 comprises the component housing 14, an insert 22 that is insertable within the internal bore 16, and a receiving fastener 24 that is supported by the vehicle body structure 12. The receiving fastener 24 has an opening 26 that is aligned with the internal bore 16. In this example, a fastener 28 (FIG. 6A-C) cooperates with the insert 22 positioned within the internal bore 16 to secure the housing 14 to the vehicle body structure 12 via the receiving fastener 24. In one example, the receiving fastener 24 comprises a threaded fastener such as a J/U clip nut, a weld nut, or any type of fastener with integrated threads. In one example, the fastener 28 comprises a standard threaded fastener such as a bolt, for example.

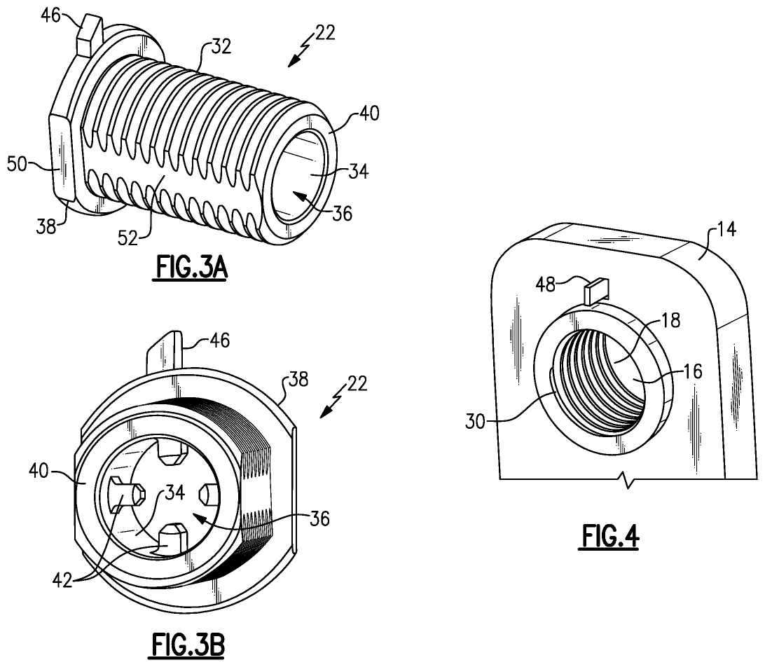

The insert 22 is shown in greater detail in FIGS. 3A-3B and the internal bore 16 of the housing is shown in greater detail in FIG. 4. In one example, the internal bore 16 comprises a threaded bore with threads 30. In one example, the threaded internal bore 16 comprises threads 30 that are integrated into the housing itself via a molding process. In one example, the insert 22 comprises a threaded outer surface 32 that threadably engages the threads 30 of the threaded bore 16 via a threaded interface such that rotation of the fastener 28 causes the insert 22 to rotate relative to the housing 14. In one example, the insert 22 comprises an inner surface 34 that defines an insert bore 36 that extends from a head 38 to a distal end 40 of the insert 22. As shown in FIG. 3B, in one example, the insert 22 includes a plurality of thread grabbers 42 that extend radially inward from the inner surface to engage outer threads 44 on the fastener 28. The thread grabbers 42 are discrete members or fingers that are circumferentially spaced apart from each outer about the bore surface 18. In one example, the threaded outer surface 32 and the thread grabbers 42 are integrally formed on the insert 22.

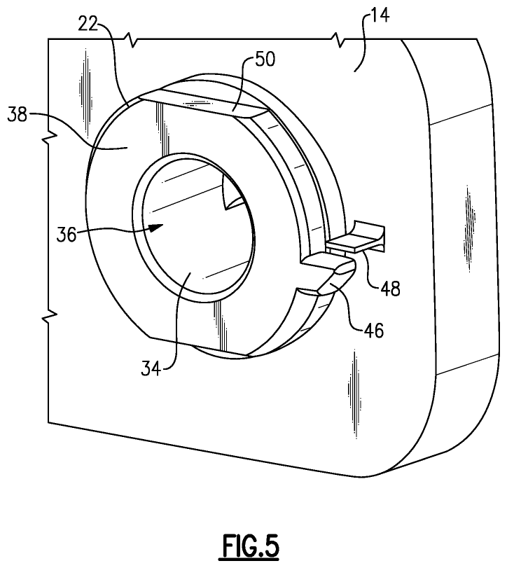

In one example, the insert 22 includes a first anti-rotation feature 46 that cooperates with a second anti-rotation feature 48 (FIG. 4) on the housing 14 to prevent rotation of the insert 22 out of the housing 14 in a first condition. For example, the first condition may comprise a shipping condition where the first 46 and second 48 anti-rotation features cooperate with each other (FIG. 5) to prevent the insert 22 from backing out during shipping. Thus, the insert 22 can be pre-installed within the housing 14 to facilitate subsequent installation of the tolerance compensation device 20 on the vehicle. During a second condition, e.g., an installation condition, a rotational force of the fastener 28 within the insert 22 overrides the first 46 and second 48 anti-rotation features to attach the housing 14 to the vehicle body structure 12.

In one example, the first anti-rotation feature 46 is integrally formed with the insert 22 and the second anti-rotation feature 48 is integrally formed with the housing 14. In one example, the head 28 includes a flat portion 50 to facilitate installation, and the body includes a flat portion 52 that facilitates injection molding while also making a pocket area within the housing 14 to make it easier to thread the insert 22 into the housing 14 and prevent binding.

FIGS. 6A-C show an installation process for the tolerance compensation device 20. As shown in FIG. 6A, a joint between the housing 14 and the vehicle body structure 12 is intentionally configured with a gap 54 to account for a tolerance stack-up. The insert 22 is pre-installed in the housing 14 by being threaded into engagement with the threads 30 of the internal bore 16 of the housing 14. In this pre-installation position, the head 38 of the insert 22 is in an initial position that is spaced from the vehicle body structure 12 by the gap 54. The fastener 28 is inserted into the insert bore 36 and engages the plurality of thread grabbers 42, which causes the insert 22 to rotate via the threaded interface between the insert 22 and the housing 14 to move the insert 22 along a linear path to a final position where the gap 54 is closed/eliminated and the head 38 of the insert 22 abuts against the vehicle body structure 12 as shown in FIG. 6B. Once the gap 54 is closed, the fastener 28 runs in the remaining threads along the body of the fastener 28 and is torqued to make the joint as shown in FIG. 6C. When the insert 22 is in this final installation position, a distal end 56 of the fastener 28 is received within the opening 26 of the receiving fastener 24 to secure the housing 14 to the vehicle body structure 12 via the joint. In the example shown in FIGS. 6A-C, the receiving fastener 24 is a U-shaped nut with first and second legs 58 having aligned openings 26 and a threaded portion 60 that engages with the distal end 56 of the fastener 28. As shown in FIG. 6, in the final installation position, a head 62 of the fastener 28 abuts against the distal end 40 of the insert 22.

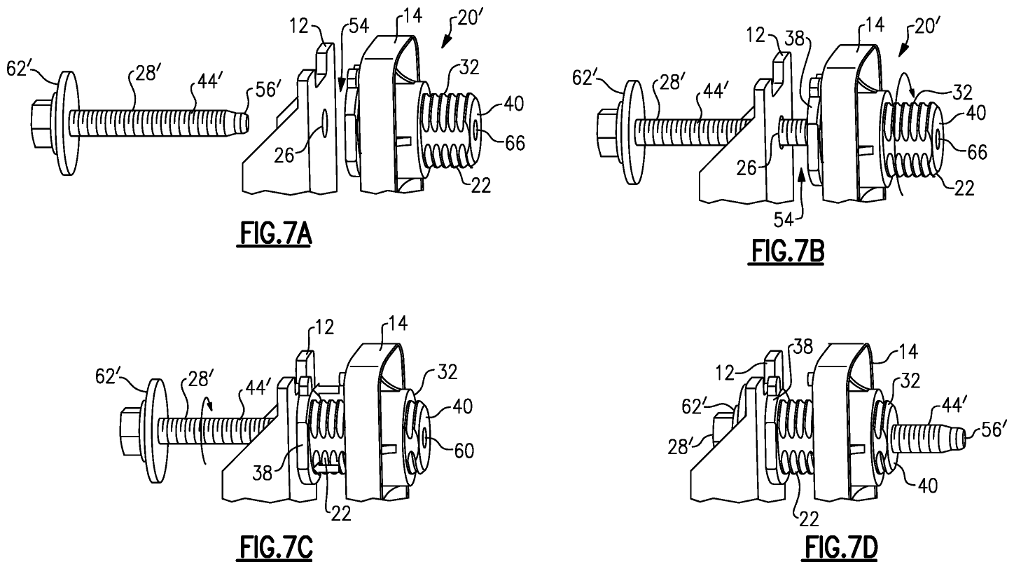

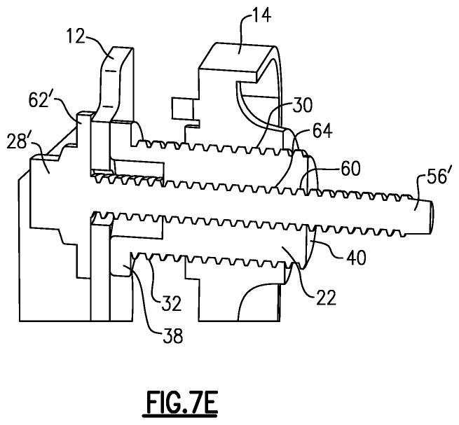

FIGS. 7A-E show another example of a tolerance compensation device 20′. In this example, the fastener comprises a self-threading fastener 28′. In this example, it is a reversed stack-up with the fastener 28′ being installed through the vehicle body structure 12 before entering the insert 22 in the housing 14. With regard to the interface between the insert 22 and the housing 14, it remains the same as that in FIGS. 6A-C but the integrated threads on the insert 22 and the housing bore 16 are changed to reverse thread. All other features on the housing 14 and insert 22 remain the same and function in the same way as described above.

In this example, the thread grabbers 42 are replaced with a simple through-hole that is sized for the self-threading fastener 28′.

As shown in FIG. 7A, a joint between the housing 14 and the vehicle body structure 12 is intentionally configured with the gap 54 to account for a tolerance stack-up. The insert 22 is pre-installed in the housing 14 by being threaded into engagement with the threads 30 of the internal bore 16 of the housing 14. In this pre-installation position, the head 38 of the insert 22 is in an initial position that is spaced from the vehicle body structure 12 by the gap 54. The insert 22 comprises an inner surface 64 (FIG. 7E), e.g. a smooth surface, that defines an insert bore 66 that extends from the head 38 to the distal end 40 of the insert 22. The fastener 28′ comprises a self-threading fastener with threads 44′ that cut into the inner surface 64 to rotate the insert 22 relative to the housing 14 as shown in FIG. 7B. The head 38 of the insert 22 is in an initial position that is spaced from the vehicle body structure 12 by the gap 54 and the self-threading fastener 28′ rotates the insert 22 to a final position where the gap 54 is eliminated and the head 38 of the insert 22 abuts against the vehicle body structure 12 as shown in FIG. 7C. Then the fastener 28′ continues to rotate through the insert 22 such that the head 62′ of the fastener 28′ abuts against the vehicle body structure 12 and the distal end 56′ of the fastener 28′ extends outwardly of the insert 22 as shown in FIG. 7D. Thus, once the gap 54 is closed, the fastener 28 self-threads through the insert bore 66 and is torqued to make the joint as shown in FIG. 7E.

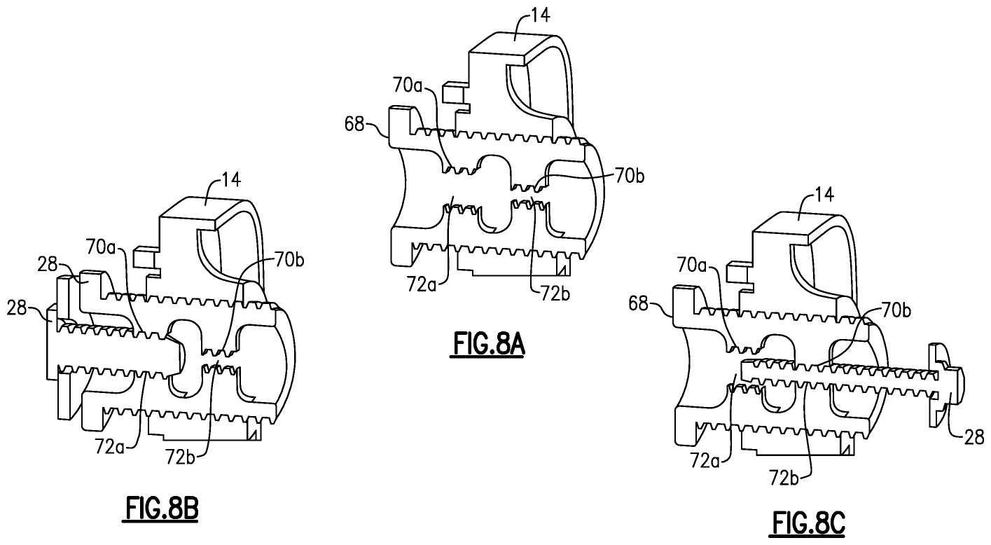

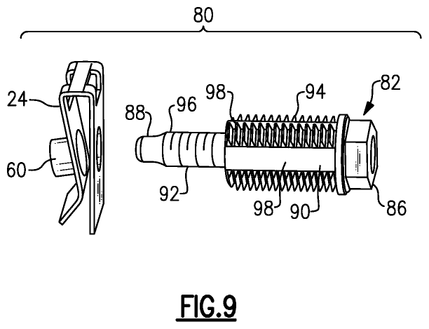

FIGS. 8A-C show an example of an insert configuration where an insert 68 includes two sets of thread grabbers 70a, 70b. The thread grabbers 70a, 70b have bores 72a, 72b that receive the fastener 28. The bores 72a, 72b can be smooth for self-threading fasteners or can be threaded for standard fasteners. As shown in FIG. 8A, a first bore 72a for the thread grabber 70a is defined by a diameter that is greater than a diameter of a second bore 72b of the other of the thread grabbers 70b. This allows for a configuration where the insert 68 can accept fasteners having different sizes.

For example, FIG. 8B shows a body side installation where a shorter fastener 28 is installed into the first bore 72a. The a shorter fastener 28 has a larger diameter with more threads so that it will not bottom out onto the other set of thread grabbers 70b.

FIG. 8C shows a component side installation configuration where a longer fastener 28 is installed into the second bore 72b. This fastener 28 is smaller/thinner such that it can easily extend through the other set of thread grabbers 70a.

Thus, the insert 68 comprises a configuration where the fastener 68 is selectable between at least a first fastener 28 having a first size and a second fastener 28 having a second size different than the first size. The insert 68 comprises an inner surface that defines an insert bore 74 that extends from the head to a distal end of the insert 68, and the insert bore 74 includes a first internal feature, e.g., first thread grabbers 70a, to accommodate the first fastener and a second internal feature, e.g., second thread grabbers 70b, to accommodate the second fastener.

In any of the disclosed configurations, the inserts comprise molded plastic parts that can be used for many different types of connection interfaces on a vehicle such as lighting applications, fenders, brackets, interior/exterior trim, for example. This type of integrated part eliminates corrosion issues of multiple metal parts and eliminates metal to metal interfaces of fastener, adjuster, body, and reduces a chance of galvanic corrosion.

In one example, the vehicle body structure 12 comprises a metal (steel/aluminum) body component or a plastic, e.g., polypropylene, material. In one example, the receiving fastener 24 comprises a U-nut made from steel. In one example, the housing 14 comprises a plastic, e.g., polypropylene, material. In one example, the inserts comprise a plastic, e.g., polypropylene, material, a polybutylene terephthalate material, a cast/machined aluminum material, or a cast/machined steel material.

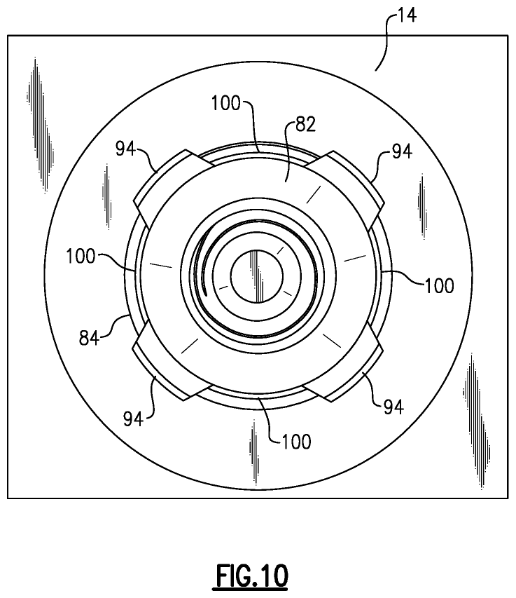

FIG. 9 shows another example of a tolerance compensation device 80 where a fastener 82 includes threads that cut into a bore surface 84 (FIG. 10) of the housing 14 as the fastener 82 is rotated relative to the housing 14 to secure the housing 14 to the vehicle body structure 12. In one example, the fastener 82 extends from a head 86 to a distal end 88, and further comprises a first body portion 90 extending from the head 86 and a second body portion 92 extending from the first body portion 90 to the distal end 88. The first body portion 90 is defined by a first diameter and the second body 92 portion is defined by a second diameter that is less than the first diameter. In one example, the threads of the fastener 82 comprise a first set of threads 94 formed on the first body portion 90 and a second set of threads 96 formed on the second body portion 92. In one example, the first set of threads 94 are self-cutting threads and the second set of threads 96 comprise machined threads. In one example, a thread pitch of both sets of threads 94, 96 are the same so that the fastener 82 threads at the same rate in both joints. Optionally, the second set of threads 96 may also be self-cutting.

In one example, the first body portion 90 includes one or more relief cuts 98, e.g., flat areas, that reduce friction during installation. These cuts 98 also provide for pockets 100 (FIG. 10) within the housing 14 that collect any shavings created by the housing or fastener to reduce any binding effect.

In one example, the first set of threads 94 cut into the bore surface 84 and the second set of threads 96 threadably engage the threaded portion 60 of the receiving fastener 24 supported by the vehicle body structure 12 as the fastener 82 is rotated within an internal bore of the housing 14. In one example, the receiving fastener 24 comprises a U-nut as described above.

In one example, the fastener 82 includes a shoulder 102 between the first body portion 90 and the second body portion 92. In one example, the fastener 82 has a hollow area 110 in the first body portion 90 to reduce weight.

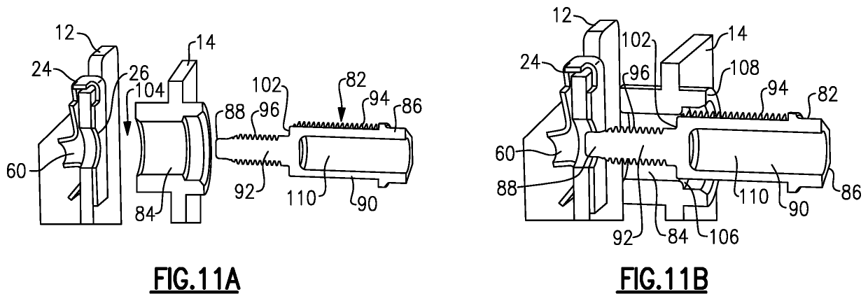

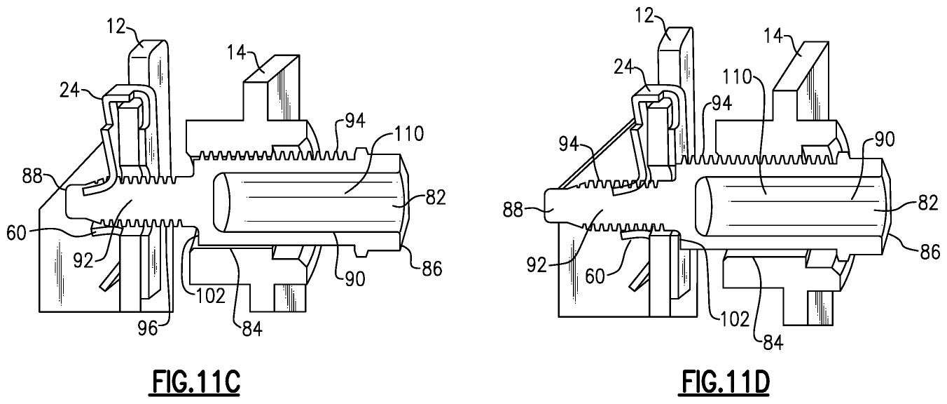

FIGS. 11A-D show an installation process for the tolerance compensation device 80. As shown in FIG. 11A, a joint between the housing 14 and the vehicle body structure 12 is intentionally configured with a gap 104 to account for a tolerance stack-up. As the fastener 82 is installed into the housing 14, the fastener 82 is first aligned via an internal step feature 106 formed within a protruding portion 108 of the housing as shown in FIG. 11B. The fastener 82 is rotated from an initial position where the shoulder 102 is spaced from the vehicle body structure 12 by a gap (FIG. 11C) to a final position where the shoulder 102 abuts against the vehicle body structure 12 to eliminate the gap (FIG. 11D). As shown in FIG. 11C, the self-cutting threads 94 tap into the bore surface 84 of the housing 14 and the machined threads 96 start to engage in the threaded portion 60 of the receiving fastener 24. As shown in FIG. 11D, once the shoulder 102 is fully against the vehicle body structure 12 via the receiving fastener 24, the joint can be fully torqued. In this position, the self-cutting threads 94 are now bonded in place with the housing 14 to keep the housing stable.

The joint for the example shown in FIGS. 11A-D works when the tolerance stack-up causes no clearance between the components. The joint for the example shown in FIGS. 11A-D also works when the tolerance stack-up causes there to be a gap between the components when installed. The depth of the self-cutting threads 94 allows for various tolerance stack-ups and joint thicknesses and is configured to self-adjust for any clearance between minimum and maximum designs for the joint.

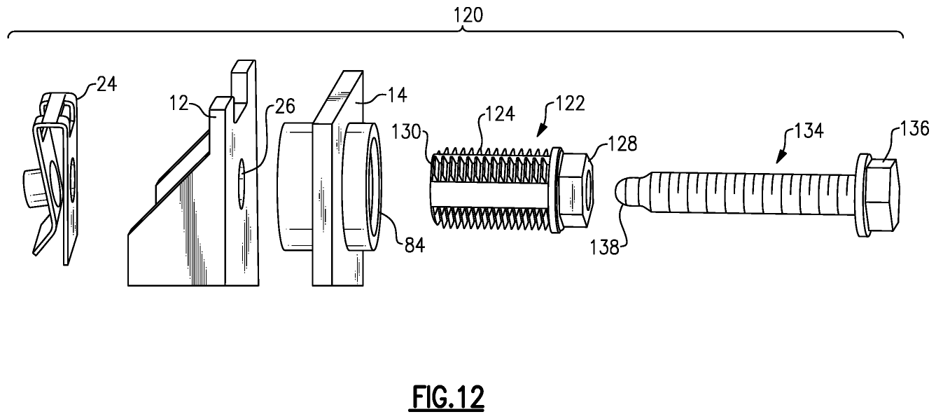

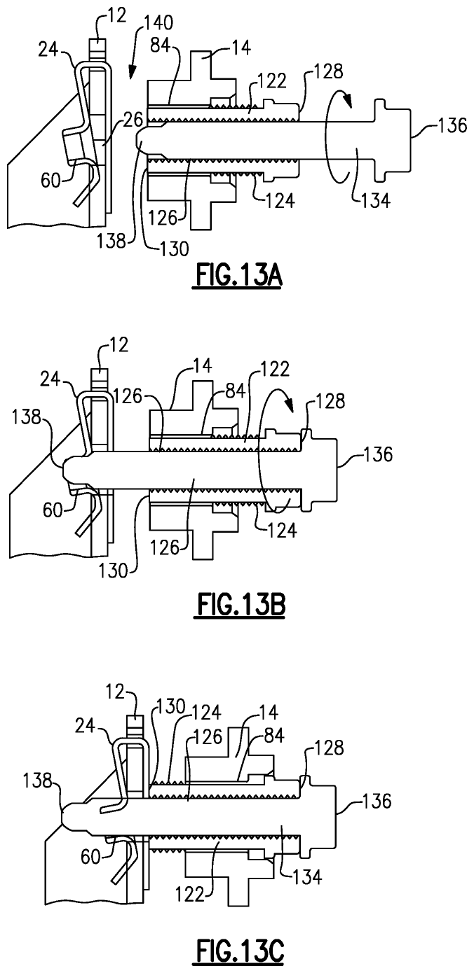

FIG. 12 shows another example of a tolerance compensation device 120 where a fastener 122 includes threads 124 that cut into the bore surface 84 of the housing 14 as the fastener 122 is rotated relative to the housing 14 to secure the housing 14 to the vehicle body structure 12. In the example, the fastener 122 comprises a first fastener 122 and the threads comprise external threads 124. The threads 124 are formed as the same self-tapping threads of the first body portion 90 of the fastener 82 as described above. In one example, the first fastener 122 includes a bore 126 (FIGS. 13A-C) that extends from a head 128 of the first fastener 122 to a distal end 130 of the first fastener 122. In one example, the bore 126 includes internal threads 132 that cooperate with a second fastener 134. In one example, the second fastener 134 extends from a head 136 to a distal end 138, and comprises a standard threaded bolt.

FIGS. 13A-C show an installation process for the tolerance compensation device 120. As shown in FIG. 13A, a joint between the housing 14 and the vehicle body structure 12 is intentionally configured with a gap 140 to account for a tolerance stack-up. The second fastener 134 is threaded into the bore 126 of the first fastener 122 as shown in FIG. 13A. The second fastener 134 is threaded into the bore 126 until the head 136 of the second fastener 134 abuts against the head 128 of the first fastener 22 as shown in FIG. 13B. Once the head 136 engages the other head 128, the first fastener 122 and the second fastener 134 are subsequently rotated together such that the external threads 124 cut into the bore surface 126 of the housing 14. The first fastener 122 and the second fastener 134 are rotated together until the distal end 138 of the second fastener 134 is received within the threaded portion 60 of the receiving fastener 24 and the distal end 130 of the first fastener 122 engages with vehicle body structure 12 as shown in FIG. 13C. In one example, the receiving fastener 24 comprises a U-nut as described above.

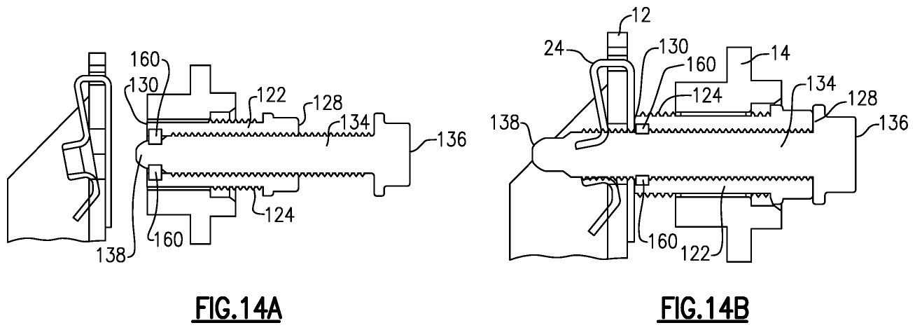

In one example, one or more break-away tabs 160 cooperate with the distal end 138 of the second fastener 134 as shown in FIG. 14A. The tabs 160 catch the fastener 134 from threading all the way through until it turns in the self-tapping insert. The tabs 160 break away for the fastener 134 to pass through once the tolerance gap is completed as shown in FIG. 14B.

The subject disclosure provides for a tolerance compensator that is a simple and light weight design, and which can be easily integrated into the main component assembly, e.g., headlamp. The subject tolerance compensator has a reduced number of parts compared to prior designs and can be integrated into an injection mold of many plastic components on the vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly comprising:
a housing having an internal bore defined by a bore surface;
a fastener insertable within the internal bore;
a receiving portion within a vehicle body structure that has an opening that is aligned with the internal bore; and
wherein the fastener includes threads that cut into the bore surface as the fastener is rotated relative to the housing to secure the housing to the vehicle body structure via the receiving portion, or
wherein the fastener cooperates with an insert positioned within the internal bore to secure the housing to the vehicle body structure via the receiving portion.

2. The assembly of claim 1, wherein the internal bore comprises a threaded bore and wherein the insert comprises a threaded outer surface that threadably engages the threaded bore via a threaded interface such that rotation of the fastener causes the insert to rotate until a head of the insert abuts against the vehicle body structure.

3. The assembly of claim 2, wherein the insert comprises an inner surface that defines an insert bore that extends from the head to a distal end of the insert, and wherein the insert includes a plurality of thread grabbers that extend radially inward from the inner surface to engage outer threads on the fastener.

4. The assembly of claim 3, wherein the head of the insert is in an initial position that is spaced from the vehicle body structure by a gap, and wherein the fastener engages the plurality of thread grabbers causing the insert to rotate via the threaded interface between the insert and the housing to move the insert to a final position where the gap is eliminated and the head of the insert abuts against the vehicle body structure.

5. The assembly of claim 4, wherein the receiving portion comprises a receiving fastener, and wherein when the insert is in the final position, the fastener is rotated through the insert such that a distal end of the fastener is received within the opening of the receiving fastener to secure the housing to the vehicle body structure.

6. The assembly of claim 2, wherein the insert comprises an inner surface that defines an insert bore that extends from the head to a distal end of the insert, and wherein the fastener comprises a self-threading fastener that cuts into the inner surface to rotate the insert relative to the housing.

7. The assembly of claim 6, wherein the receiving portion comprises a receiving fastener, and wherein the head of the insert is in an initial position that is spaced from the vehicle body structure by a gap, and wherein the self-threading fastener rotates the insert to a final position where the gap is eliminated and the head of the insert abuts against the vehicle body structure, and wherein the fastener rotates through the insert such that a distal end of the fastener extends outwardly of the insert.

8. The assembly of claim 2, wherein the insert includes a first anti-rotation feature that cooperates with a second anti-rotation feature on the housing to prevent rotation of the insert out of the housing in a first condition, and wherein, in a second condition, a rotational force of the fastener within the insert overrides the first and second anti-rotation features to attach the housing to the vehicle body structure.

9. The assembly of claim 2, wherein the fastener is selectable between at least a first fastener having a first size and a second fastener having a second size different than the first size, and wherein the insert comprises an inner surface that defines an insert bore that extends from the head to a distal end of the insert, and wherein the insert bore includes a first internal feature to accommodate the first fastener and a second internal feature to accommodate the second fastener.

10. The assembly of claim 1, wherein the fastener includes threads that cut into the bore surface.

11. The assembly of claim 10, wherein the fastener extends from a head to a distal end, and wherein the fastener comprises a first body portion extending from the head and a second body portion extending from the first body portion to the distal end, wherein the first body portion is defined by a first diameter and the second body portion is defined by a second diameter that is less than the first diameter, and wherein the threads comprise a first set of threads formed on the first body portion and a second set of threads formed on the second body portion.

12. The assembly of claim 11, wherein the receiving portion comprises a receiving fastener, and wherein the first set of threads cut into the bore surface and the second set of threads threadably engage the opening in the receiving fastener as the fastener is rotated within the internal bore.

13. The assembly of claim 12, wherein the fastener includes a shoulder between the first body portion and the second body portion, and wherein the fastener is rotated from an initial position where the shoulder is spaced from the vehicle body structure by a gap to a final position where the shoulder abuts against the vehicle body structure to eliminate the gap.

14. The assembly of claim 10, wherein the fastener comprises a first fastener and the threads comprise external threads, and wherein the first fastener includes a bore that extends from a head of the first fastener to a distal end of the first fastener, and wherein the bore includes internal threads that cooperate with a second fastener.

15. The assembly of claim 14, wherein the second fastener extends from a head to a distal end, and wherein the second fastener is threaded into the bore of the first fastener until the head of the second fastener abuts against the head of the first fastener, and wherein the first fastener and the second fastener are subsequently rotated together such that the external threads cut into the bore surface of the housing.

16. The assembly of claim 15, wherein the receiving portion comprises a receiving fastener, and wherein the first fastener and the second fastener are rotated together until the distal end of the second fastener is received within the opening of the receiving fastener and the distal end of the first fastener engages with vehicle body structure.

17. A method comprising:
inserting a fastener into an internal bore in a housing, wherein the internal bore is defined by a bore surface;
providing a receiving portion with a vehicle body structure such that an opening in the receiving portion is aligned with the internal bore; and
cutting into the bore surface with external threads on the fastener as the fastener is rotated relative to the housing to secure the housing to the vehicle body structure via the receiving portion, or
positioning an insert with in the internal bore to cooperate with the fastener to secure the housing to the vehicle body structure via the receiving portion.

18. The method of claim 17, including positioning the insert with in the internal bore, and wherein the internal bore comprises a threaded bore and wherein the insert comprises a threaded outer surface that threadably engages the threaded bore via a threaded interface, and including rotating the fastener to cause the insert to rotate until a head of the insert abuts against the vehicle body structure.

19. The method of claim 18, wherein the insert comprises an inner surface that defines an insert bore that extends from the head to a distal end of the insert, and wherein:
the insert includes a plurality of thread grabbers that extend radially inward from the inner surface to engage outer threads on the fastener, or
the fastener comprises a self-threading fastener.

20. The method of claim 17, wherein the receiving portion comprises a receiving fastener, and including cutting into the bore surface with external threads on the fastener as the fastener is rotated relative to the housing to secure the housing to the vehicle body structure via the receiving fastener.
